(19) United States
(12) Patent Application Publication
(10) Pub. No.: US 2020/0392886 A1
(43) Pub. Date: Dec. 17, 2020

(54) ANTI-RATTLING EXHAUST VALVE

(71) Applicant: FAURECIA SYSTEMES D'ECHAPPEMENT, Nanterre (FR)

(72) Inventors: Raphaël DE MATOS, SAONE (FR); Alexandre NANEIX, MONTBELIARD (FR)

(21) Appl. No.: 16/901,119

(22) Filed: Jun. 15, 2020

(30) Foreign Application Priority Data
Jun. 17, 2019 (FR) 19 06441

(51) Int. Cl. F01N 13/08; F02D 9/04; F02D 9/10; F16D 3/72; F16K 1/22

(52) U.S. Cl. CPC F01N 13/08; F02D 9/04; F16K 31/045; F16D 3/72; F16K 1/221; F02D 9/1065

(57) ABSTRACT

An exhaust valve comprises a body, a shaft rotating relative to the body along a first axis of symmetry, a gate secured to the shaft, a ball joint hinging the shaft relative to the body, and an interface comprising a power take-off. The power take-off has a misalignment relative to the first axis of symmetry.

### CROSS REFERENCE TO RELATED APPLICATIONS

This application is a U.S. non-provisional application claiming the benefit of French Application No. FR 19 06441, filed on Jun. 17, 2019, which is incorporated herein by its entirety.

### TECHNICAL FIELD

The present disclosure relates to the field of exhaust valves. An exhaust valve is typically positioned in an exhaust line, downstream from an internal combustion engine. The exhaust valve is conventionally used:
in relation with a tapping of said line to selectively withdraw at least part of the exhaust gases toward an exhaust gas recirculation (EGR),
in bypass, in order to steer all or part of the exhaust gases toward a heat recovery device,
as a device making it possible to generate a back-pressure for acoustic purposes.

### BACKGROUND

As illustrated in FIG. 1, it is known to produce an exhaust valve 1, comprising a body 2, a shaft 3, a gate 4, two bearings 5, 6, a ball joint, and an interface 10. The body 2 is hollow tubular, for example in the form of a generalized cylinder. The body 2 has a first passage section S. The two bearings 5, 6 are positioned and secured, on either side, diametrically, in the walls of the body 2. The shaft 3 passes through the body 2 and is engaged on each side, with one of its ends in each of the two bearings 5, 6. Thus, the shaft 3 can rotate, relative to the body 2, about a first axis A of symmetry of the shaft 3. The gate 4 is secured to the shaft 3 and positioned inside the body 2. The gate 4 has a second section S′ substantially identical to the first section S, in a lower manner Thus, the gate 4, rotated by the shaft 3, can rotate between a closed position, where the second section S′ of the gate 4 closes off the first section S of the body 2 while facing the stream of gas, thus closing the valve 1, and a retracted position, substantially perpendicular to the closed position, where the gate 4 has its thickness, which is small, facing the stream of gas, allowing the gas to pass and thus opening the valve 1.

In light of a use in an exhaust line, such an exhaust valve 1 is subject to high temperatures, and above all to temperature variations having broad ranges. Therefore, in order to accommodate the significant differential thermal expansions, the rotary connections between the shaft 3 and the bearings 5, 6 have significant play. This play causes travel of the shaft 3 in the bearings 5, 6 that may be significant. Under the effect of vibrations and/or pressure pulses transmitted to the shaft 3, this travel causes significant and repeated impacts of the shaft 3 against the bearings 5, 6, or of the gate 4 against the body 2, which may cause wear and/or breaking of said parts in contact and additionally produce rattling, which is a source of noise annoyance.

Said play is further the cause of a gas leak at the bearings 5, 6. In order to ensure gas tightness, it is known to position a ball joint 7 between the shaft 3 and the body 2. Such a ball joint 7 comprises a female part 8 secured to one part among the body 2 or the shaft 3 and a male part 9 secured to the other part among the body 2 or the shaft 3, the two parts 8, 9 being positioned to face one another and to be able to come into contact with one another. This makes it possible, under the effect of a force, substantially aligned with the axis A of the shaft 3, to press the male part 9 against the female part 8, and thus to ensure gas tightness between the shaft 3 and the body 2. Such an arrangement further makes it possible to accommodate the differential thermal expansions.

The valve 1 further comprises an interface 10. This interface 10 is secured to the shaft 3, most often positioned at the end of said shaft 3, and able to transmit the torques and forces that it receives to said shaft 3. The interface 10 typically makes it possible to interface the valve with an actuator. The actuator then transmits a rotational torque, in one direction, for opening, or in another direction, for closing, about the first axis A. The actuator, for example using a coupling including a resilient member, also transmits a force along the first axis A, able to produce the tightness at the ball joint 7. The interface 10 is further able to transmit said force along the first axis A in at least one direction, advantageously the direction bringing the two parts 8, 9 of the ball joint 7 closer together, in order to ensure the tightness. In order to allow the interface with the actuator, the interface 10 comprises a power take-off 11 able to accommodate a complementary power take-off connected to the actuator to receive said torque and/or force.

The drawback of such a valve 1 is primarily the travel, with its detrimental consequences in terms of mechanical wear and noise annoyance.

### SUMMARY

The disclosure relates to: an exhaust valve, comprising a hollow tubular body having a first passage section, a shaft passing through the body and engaged on each side in a respective bearing secured to the body in order to allow a rotation of the shaft, relative to the body, along a first axis of symmetry of the shaft, a gate secured to the shaft, positioned in the body, having a second section substantially identical to the first section, a ball joint hinging the shaft relative to the body and an interface, secured to the shaft to transmit, to said shaft, any rotational torque about the first axis and a force along the first axis, the interface comprising a power take-off able to receive said torque and/or force, the power take-off having a misalignment relative to the first axis to create a lever arm able to transform a force applied to the interface along the first axis into a torque about a second axis perpendicular to the first axis.

Specific features or embodiments, usable alone or in combination, are:
the ball joint includes a female part such as a hollow conical part and a male part such as a solid hemispherical part, the opening of the female part facing the male part, one of the two parts being secured to the body and the other of the two parts being secured to the shaft, and the two parts being positioned to come into contact with one another,
the torque generated by the misalignment is at least equal to 0.05 Nm,
the profile of the power take-off is rectilinear,
the power take-off is a rectilinear bar or a rectilinear notch.

In a second aspect, the disclosure relates to an exhaust line comprising such a valve.

In a third aspect, the disclosure relates to a vehicle comprising such an exhaust line.

### BRIEF DESCRIPTION OF THE DRAWINGS

The disclosure will be better understood upon reading the following description, provided solely as an example, and in reference to the appended figures, in which:

FIG. 1, already described, shows, in perspective view, a valve according to the prior art,

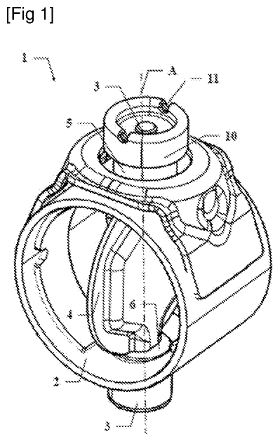

FIG. 2 shows, in perspective view, a modified valve according to a first embodiment of the disclosure, and

FIG. 3 shows, in cut front view, a modified valve according to another embodiment of the disclosure.

### DETAILED DESCRIPTION

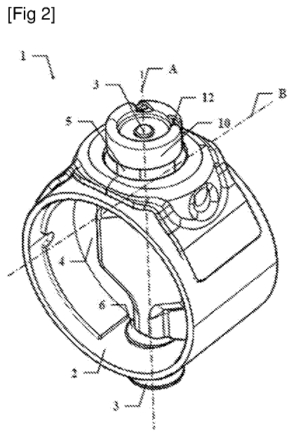

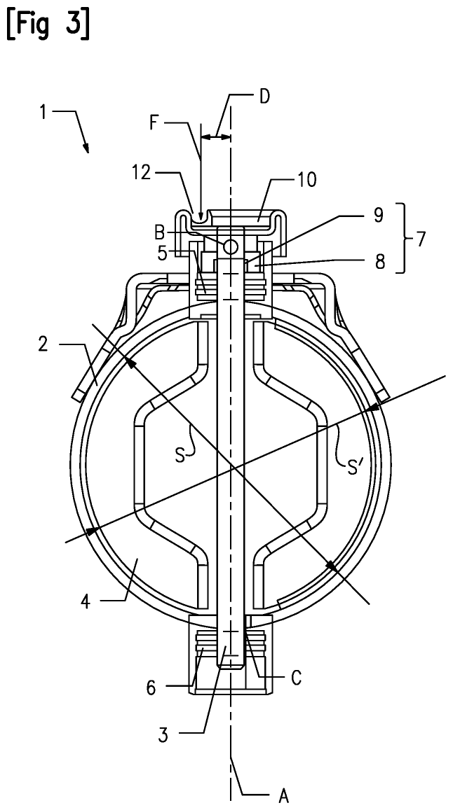

In reference to FIGS. 2 and 3, a valve 1 according to the disclosure is similar to a valve 1 according to the prior art. The description previously given in the prior technical section applies in its entirety.

It may be specified that the ball joint 7 is, most often, positioned outside the two bearings 5, 6. The reverse is also possible.

Likewise, the interface 10 is most often positioned outside the two bearings 5, 6. The reverse is also possible.

The interface 10 is, for example as illustrated, positioned on the same side, relative to the bearings 5, 6, as the ball joint 7. However, the opposite configuration, where the interface 10 is positioned on the opposite side from the ball joint 7, is also possible. The valve 1 further includes the interface 10, which in one example, comprises an interface organ such as a coupler or connector component that interfaces with an actuator.

The two parts 8, 9 of the ball joint 7 are advantageously positioned to come closer to one another when a force is exerted on the interface 10 toward the body 2. However, the reverse configuration, the two parts 8, 9 of the ball joint 7 being positioned to come closer to one another when a force is exerted on the interface 10 moving away from the body 2, with an actuator applying a force moving away from the body 2, in traction, is also possible.

The points modified by the disclosure will now be described more specifically.

While the power take-off 11 according to the prior art is systematically centered, according to one important feature of the disclosure, the power take-off 12 according to the disclosure has a misalignment D relative to the first axis A. This is intended to create a lever arm. This lever arm makes it possible to transform a force F applied to the interface 10 along the first axis A into a torque about a second axis B perpendicular to the first axis A. Indeed, the lever arm produced by the misalignment D transforms a force applied along the first axis A, via the ball joint 7, into a torque about a second axis B perpendicular to the first axis A and passing through the center of the ball joint 7. This torque results in applying, to the shaft 3, a rotation centered on the ball joint 7, about the second axis B. This rotation results in creating a bearing C of the shaft 3 on the bearing furthest from the ball joint 7, here the bearing 6. This bearing C, maintained by the maintenance of the force F along the axis A, ensures a sustained contact of the shaft 3 with said bearing furthest from the ball joint 7 and prevents any impact between the shaft 3 and the bearing 6 furthest from the ball joint 7, but also, in so doing, prevents any impact between the shaft 3 and the other bearing 5, the bearing closest to the ball joint 7, here the bearing 5. Thus, by ensuring sustained contact C, the disclosure eliminates the drawback of the prior art.

According to another feature of the disclosure, the ball joint 7 includes a female part 8, such as a hollow conical part 8, and a male part 9, such as a solid hemispherical part 9. These two parts are positioned such that the opening of the female part 8 faces the male part 9. One of the two parts 8, 9 is secured to the body 2, while the other of the two parts 8, 9 is secured to the shaft 3. The two parts 8, 9 are relatively positioned to come into contact with one another, under the effect of the force F.

According to one embodiment, the conical part 8 is made using a conical washer. According to one embodiment, the hemispherical part 9 is made using a spherical washer.

According to another feature, the part 8, 9 secured to the body 2 is positioned outside the bearings 5, 6.

According to another feature, the misalignment D must be sufficient for the part of the force along the first axis A with “diverted” torque to be sufficient to ensure maintenance of the contact C between the shaft 3 and the remote bearing 6, but not unreasonably greater. Indeed, any needless supplement is harmful in that it creates too much bearing C of the shaft 3 on the remote bearing 6, which may be a source of increased wear in this location or be the cause of increased return friction force on the actuator, requiring an increase in the power of the latter.

In order to perform the desired function of maintaining contact between the shaft 3 and the remote bearing 6, the misalignment D is dimensioned to produce a torque at least equal to 0.05 Nm.

According to another feature, the profile of the power take-off 12 is rectilinear. This feature allows a degree of freedom along a direction perpendicular to a ray bearing the misalignment D, or along the direction of the power take-off 12. This degree of freedom allows automatic positioning of the power take-off of the actuator, which interfaces with the power take-off 12, in translation along the direction of the power take-off 12.

In order to achieve the preceding feature, the power take-off 12 is a rectilinear bar, that is to say a solid form, or a rectilinear notch, that is to say a hollow form.

The rectilinear bar or notch can have any orientation with respect to the orientation of the gate 4.

According to another embodiment, the profile of the power take-off that receives the torque about the second axis is rectilinear, while the profile of the power take-off receiving the force applied to the interface along the first axis is periodic.

The disclosure further relates to an exhaust line comprising such a valve 1.

The disclosure has been illustrated and described in detail in the drawings and the preceding description. The latter must be considered to be illustrative and provided as an example, and not as limiting the disclosure to this description alone. Many embodiment variants are possible.

### LIST OF REFERENCE SIGNS

1: valve,
2: body,
3: shaft,
4: gate,
5, 6: bearing,
7: ball joint,
8: female part, conical,
9: male part, hemispherical,
10: interface,
11: power take-off according to the prior art,
12: power take-off according to the disclosure,
A: axis of the shaft,
B: axis perpendicular to the axis A,
C: contact, bearing,
D: misalignment.

1. An exhaust valve, comprising:
a hollow tubular body having a first passage section;
a shaft passing through the hollow tubular body and engaged on each side in a respective bearing secured to the hollow tubular body in order to allow a rotation of the shaft, relative to the hollow tubular body, along a first axis of symmetry of the shaft;
a gate secured to the shaft and positioned in the hollow tubular body, the gate having a second section substantially identical to the first section;
a ball joint hinging the shaft relative to the hollow tubular body; and
an interface organ secured to the shaft to transmit, to said shaft, any rotational torque about the first axis of symmetry and at least a force along the first axis of symmetry, the interface organ comprising a power take-off able to receive said torque and/or force, wherein the power take-off has a misalignment relative to the first axis of symmetry to create a lever arm able to transform a force applied to the interface organ along the first axis of symmetry into a torque about a second axis perpendicular to the first axis of symmetry.

2. The exhaust valve according to claim 1, wherein the ball joint includes a female part such as a hollow conical part and a male part such as a solid hemispherical part, an opening of the female part facing the male part, one of the female and male parts being secured to the hollow tubular body and the other of the female and male parts being secured to the shaft, and the female and male parts being positioned to come into contact with one another.

3. The exhaust valve according to claim 1, wherein the torque generated by the misalignment is at least equal to 0.05 Nm.

4. The exhaust valve according to claim 1, wherein the power take-off has a profile that is rectilinear.

5. The exhaust valve according to claim 4, wherein the power take-off is a rectilinear bar.

6. The exhaust valve according to claim 4, wherein the power take-off is a rectilinear notch.

7. An exhaust line comprising:
an exhaust valve positioned in the exhaust line, the exhaust valve comprising
a hollow tubular body having a first passage section,
a shaft passing through the hollow tubular body and engaged on each side in a respective bearing secured to the hollow tubular body in order to allow a rotation of the shaft, relative to the hollow tubular body, along a first axis of symmetry of the shaft,
a gate secured to the shaft and positioned in the hollow tubular body, the gate having a second section substantially identical to the first section,
ball joint hinging the shaft relative to the hollow tubular body, and
an interface organ, secured to the shaft to transmit, to said shaft, any rotational torque about the first axis of symmetry and at least a force along the first axis of symmetry, the interface organ comprising a power take-off able to receive said torque and/or force, wherein the power take-off has a misalignment relative to the first axis of symmetry to create a lever arm able to transform a force applied to the interface organ along the first axis of symmetry into a torque about a second axis perpendicular to the first axis.

8. A vehicle comprising:
an exhaust line associated with the vehicle; and
an exhaust valve positioned in the exhaust line, the exhaust valve comprising a hollow tubular body having a first passage section,
a shaft passing through the hollow tubular body and engaged on each side in a respective bearing secured to the hollow tubular body in order to allow a rotation of the shaft, relative to the hollow tubular body, along a first axis of symmetry of the shaft,
a gate secured to the shaft and positioned in the hollow tubular body, the gate having a second section substantially identical to the first section,
a ball joint hinging the shaft relative to the hollow tubular body, and
an interface organ, secured to the shaft to transmit, to said shaft, any rotational torque about the first axis of symmetry and at least a force along the first axis of symmetry, the interface organ comprising a power take-off able to receive said torque and/or force, wherein the power take-off has a misalignment relative to the first axis of symmetry s to create a lever arm able to transform a force applied to the interface organ along the first axis of symmetry into a torque about a second axis perpendicular to the first axis.
